(19) United States
(12) Patent Application Publication
(10) Pub. No.: US 2007/0108718 A1
(43) Pub. Date: May 17, 2007

(54) UNIVERSAL HELPER STEP FOR CLASS 8 TRACTORS, TRAILERS AND OTHER TRUCK APPLICATIONS

(76) Inventor: Phillip C. Ruehl, Elm Grove, WI (US)

Correspondence Address: GODFREY & KAHN S.C., 780 NORTH WATER STREET, MILWAUKEE, WI, 53202, US

(21) Appl. No.: 11/554,885

(22) Filed: Oct. 31, 2006

Related U.S. Application Data
(60) Provisional application No. 60/731,749, filed on Oct. 31, 2005.
(60) Provisional application No. 60/832,453, filed on Jul. 21, 2006.

(51) Int. Cl. B60R 3/00

(52) U.S. Cl. 280/163; 280/166

(57) ABSTRACT

A helper step for a vehicle, such as a tractor, trailer or truck. The helper step has at least one mounting portion, a horizontal step member, and a pair of side supports extending between the at least one mounting portion and the horizontal step member. The helper step of the present invention can be formed as a single part from a single piece of material, and has a universal receiving slot configuration on the mounting portion that allows the helper step to be installed in connection with most any such vehicle and by one person using common home tools.

### CROSS-REFERENCE TO RELATED APPLICATIONS

This application is based upon and claims priority from Provisional Patent Application No. 60/731,749 filed on Oct. 31, 2005 and Provisional Patent Application No. 60/832,453 filed on Jul. 21, 2006, both of which are incorporated herein in their entireties for all purposes.

### BACKGROUND OF THE INVENTION

The present invention relates generally to steps for accessing a vehicle such as a tractor, trailer or truck. Specifically, this invention relates to a universal “helper” step that can be secured to an existing structure of a vehicle such as a tractor, trailer or truck to assist a driver or passenger in gaining access to the tractor, trailer or truck or part thereof.

There are approximately 1.6 million Class 8 tractors in use in the U.S., and a similar number of Class 5, 6, and 7 straight rail medium and heavy trucks. These tractors and trucks are produced by several domestic and foreign truck manufacturers, and each manufacturer typically offers multiple models and styles. Despite the large number of tractors and trucks in use and the wide variety of models and styles available, virtually all of the tractors and most of the trucks have an elevated cab that can be difficult to access.

To access the elevated cabs, two horizontal steps are typically provided. These steps are often mounted to the diesel fuel tank support strap structures. Diesel engines fire by compression, not by spark, because diesel fuel is much less combustible than gasoline. Therefore, the tanks can be, and are, mounted external to the tractor or truck frame. As shown in FIG. 1, the tanks 10 are often anchored to the frame side rails 18 by means of straps 16, which loop around the tank 10 and tie to brackets 19 on the frame siderails 18. The lower step 12 is typically mounted to the tank support straps 16 at a position that is slightly above even with the bottom of the tank 10, which is usually about 16″ to 18″ above the ground 20. The upper step 14 is typically mounted to the support straps 16 just below even with the top of the fuel tank 10, which is usually about 18″ above the lower step 12. These 18″ risers for each step are much higher than the conventional 7-8″ step risers in a home, office or commercial building. A vertical handrail is often mounted to the cab 8, just aft of the door. The driver can use this handrail to partially pull himself up the steps, in addition to lifting with his legs. Even with assistance from the handrail, the high steps can become a barrier for many drivers. For example, the driver pool now contains many older drivers and an increasing number of female drivers for whom the high steps can be difficult to use. Drivers who are short, overweight or have a physical disability could also find the current step height difficult to use. With high driver turnover rates and driver retention a major concern for the trucking industry, it is important to make the vehicles accessible for all drivers.

There are a wide variety of tanks, steps, and attachments currently in use. Most fuel tanks are round cylinders, some are square or rectangular cylinders, and others are half-round, half-rectangular. Some tractors and trucks have decorative skirts concealing the tanks, but most tanks are exposed. The steps currently in use are generally made from metal materials, either steel or aluminum stampings or aluminum extrusions. The steps are flat and thin to conserve space and weight as much as possible, but are still about 1″ to 1½″ thick to provide vertical stiffness. Most steps have surface openings for foot-traction abrasion, for water drainage, and for attachment to the tank strap structure. As shown in FIG. 1, the lower step 12 outer edge may extend outward to the maximum permissible 102″ cross-vehicle width, and rarely has any cosmetic or functional structure beneath its outer edge. The outer edge of the upper step 14 is often directly over the outer edge of the fuel tank 10, and several inches inboard of the outer edge of the lower step 12.

The only structures in the area of the vehicle convenient for cab access that are sufficiently robust to accept a driver's weight are the tank and the existing, tank-mounted steps. Again, the steps vary in pattern and in mounting to the tanks, and the tanks themselves vary in size, shape and in their mounting to the truck frame siderails. The vehicles are also subject to a strict width requirement (102″ for many vehicles). Given the limited structures available for mounting, the wide variety of tanks, steps and attachments available, and the width restrictions, no simple, inexpensive, “helper” steps are currently offered or available that would make accessing the cab easier for many drivers. In particular, an aftermarket helper step needs to be easy to mount with common tools, and retail inventory control would greatly benefit from a universal part design that fits most such vehicles.

Accordingly, a need exists for a helper step that overcomes these and other deficiencies in the prior art. Of course, the present invention may be used in a multitude of situations where similar performance capabilities are required.

### SUMMARY OF THE INVENTION

The present invention provides a helper step for a vehicle, such as a tractor or truck. The helper step has at least one mounting portion, a horizontal step member, and a pair of side supports extending between the at least one mounting portion and the horizontal step member. The mounting portion is configured to be attached to an existing structure on the vehicle and has at least one receiving slot defined thereon, the horizontal step member has at least one upwardly facing stepping surface, and the side supports are preferably oriented at an angle such that the distance between the side supports near the mounting portion is greater than the distance between the side supports near the horizontal step member.

The helper step of the present invention can be formed as a single part from a single piece of material, and can utilize a universal receiving slot configuration on the mounting portion that allows the helper step to be installed in connection with most any tractor, trailer or truck. The helper step can also include a hinge disposed in the mounting portion such that the helper step can be pivoted between a first position in which the step member is positioned below the mounting portion and a second position in which the step member is positioned above the mounting portion. The helper step of the present invention can be attached to an existing step on the vehicle to gain access to a cab of the vehicle, to an under-ride beam on the vehicle to gain access to a cargo bay or flatbed of the vehicle, or to a number of other existing structures on a vehicle.

The present invention also contemplates a step arrangement for a vehicle. The step arrangement includes a first step mounted in connection with a fuel tank support strap on a vehicle, a second step mounted in connection with the fuel tank support strap, the second step positioned above the first step, a first helper step mounted to the first step, and a second helper step mounted to the second step. Each of the helper steps include at least one mounting portion, a horizontal step member, and a pair of side supports connecting the mounting portion to the step member. The step member of the first helper step is positioned below the first step, and the step member of the second helper step is positioned above the first step but below the second step.

The universal receiving slot configuration can include at least one receiving slot that is perpendicular to at least one other receiving slot, and at least two receiving slots that are parallel to one another and parallel to the mounting edge of the existing step or other existing mounting structure on the vehicle. The helper step preferably includes two mounting portions, wherein each of the mounting portions has at least two receiving slots that are parallel to one another, and wherein the location of the parallel receiving slots on one of the mounting portions is offset from the location of the parallel receiving slots on the other mounting portion.

The present helper step invention has a number of advantages and addresses a long-felt but unsolved vehicle access problem. It provides a simple, inexpensive, and secure solution, with minimal and easy assembly. The invention overcomes the challenge of finding a solid and common anchor point among many diverse vehicle models because the universal receiving slot configuration allows the helper step to be installed to an existing structure on most all vehicles. The helper step can be formed in a number of different ways, many of which maximize material utilization and result in a one piece part formed from a single piece of material. The helper step can be installed in a number of different locations on a vehicle and be used in a number of different applications.

While one possible application of the present invention is in connection with a tractor, trailer, truck or other vehicle, many other applications are possible and references to use in connection with a tractor, trailer, truck or other vehicle should not be deemed to limit the uses of the present invention. As used herein, the term “vehicle” is intended to include the trailers used in connection with tractors, trucks and other vehicles as well as the vehicles themselves.

### BRIEF DESCRIPTION OF THE DRAWINGS

FIG. 1 is a front view of the existing two-step configuration typically used to access elevated vehicle cabs;

FIG. 2a is a front view of one embodiment of the helper step arrangement of the present invention installed in connection with the existing two-step configuration of FIG. 1;

FIG. 2b is a side view the helper step arrangement of FIG. 2a;

FIG. 2c is a top view of the helper step arrangement of FIG. 2a;

FIG. 3a is a top view of one preferred embodiment of an upper helper step according to the present invention;

FIG. 3b is a side view of the upper helper step of FIG. 3a;

FIG. 4a is a top view of one preferred embodiment of a lower helper step according to the present invention;

FIG. 4b is a side view of the lower helper step of FIG. 4a;

FIG. 5a is a top view of another embodiment of an upper helper step according to the present invention, wherein the upper helper step is made from a formed tube material;

FIG. 5b is a side view of the upper helper step of FIG. 5a;

FIG. 6a is a top view of another embodiment of an upper helper step according to the present invention, wherein the upper helper step is made from a bent strap material;

FIG. 6b is a side view of the upper helper step of FIG. 6a;

FIG. 7a is a top view of another embodiment of a portion of an upper helper step according to the present invention, wherein the upper helper step is made from a twisted extrusion or bar material;

FIG. 7b is a front view of the upper helper step of FIG. 7a;

FIG. 7c is a side view of the portion of the upper helper step of FIG. 7a;

FIG. 8a is a side view of another embodiment of a portion of an upper helper step according to the present invention, wherein the upper helper step is made from a combination of metal and rope materials and includes a self-orienting step member;

FIG. 8b is a top view of the self-orienting step member of FIG. 8a;

FIG. 8c is a side view of another embodiment of a portion of an upper helper step according to the present invention, wherein the upper helper step is made from a combination of metal and rope materials and does not include a self-orienting step member;

FIG. 9 is a front view of another embodiment of a helper step arrangement according to the present invention, wherein a single helper step can pivot between a first and second position;

FIG. 10a is an enlarged front view of the helper step arrangement of FIG. 9, showing both the first and second positions;

FIG. 10b is a side view of the helper step arrangement of FIG. 10a, showing both the first and second positions;

FIG. 11a is a top view of a strap attachment used in connection with one embodiment of the present invention, wherein a helper step of the present invention is fastened to a rear under-ride beam for use in gaining access to a vehicle cargo bay or flat bed;

FIG. 11b is a front view of the strap attachment of FIG. 11a;

FIG. 11c is a cross-sectional end view of the strap attachment of FIG. 11b, taken along line 11c-11c in FIG. 11b;

FIG. 12a is a rear view of another embodiment of the present invention, wherein a helper step is mounted to a rear under-ride guard beam of a vehicle; and

FIG. 12b is a top view of the helper step of FIG. 12a.

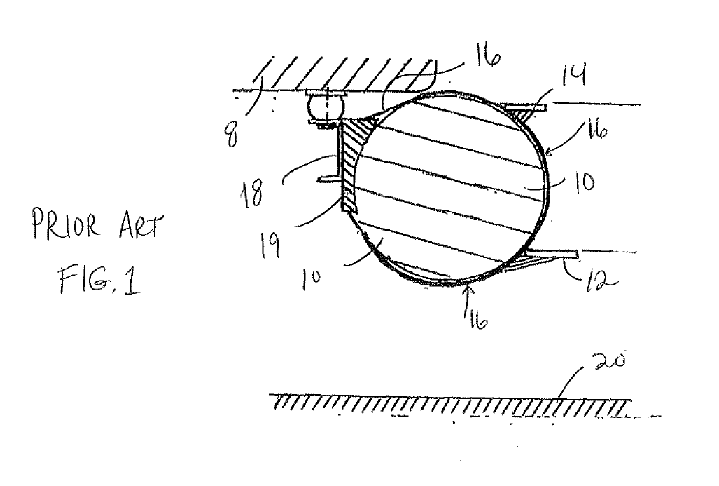

### DETAILED DESCRIPTION OF THE PREFERRED EMBODIMENTS

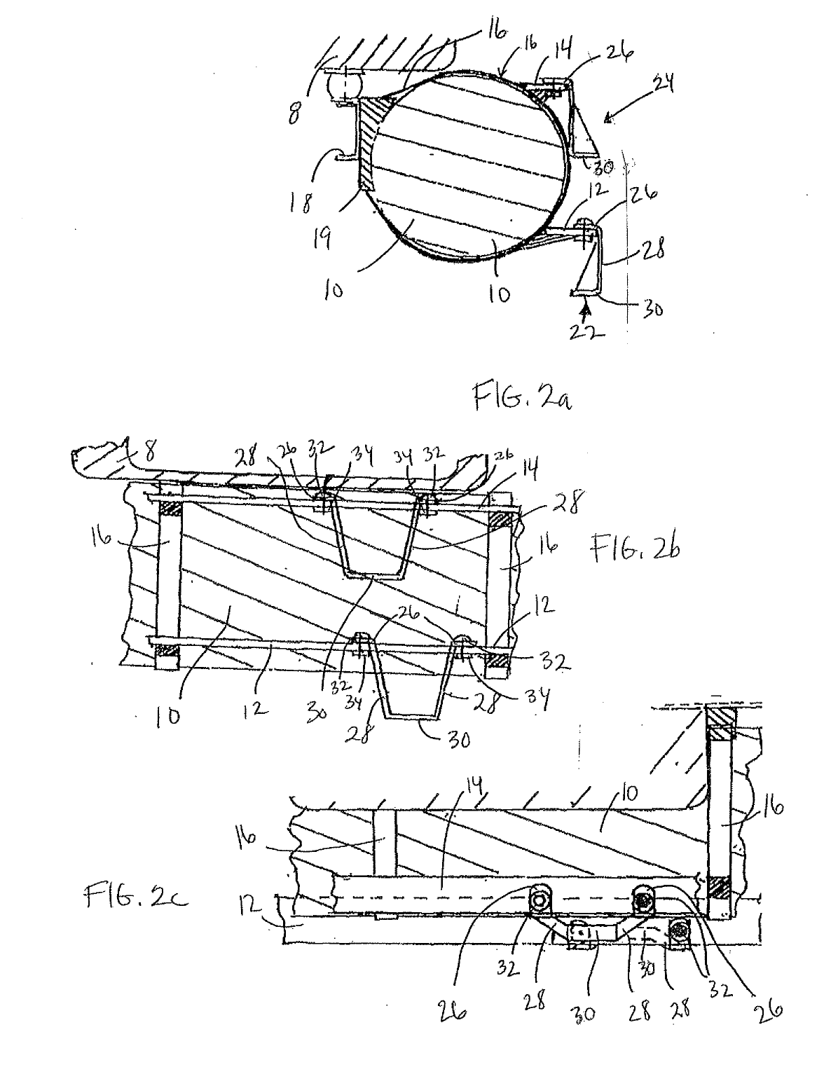

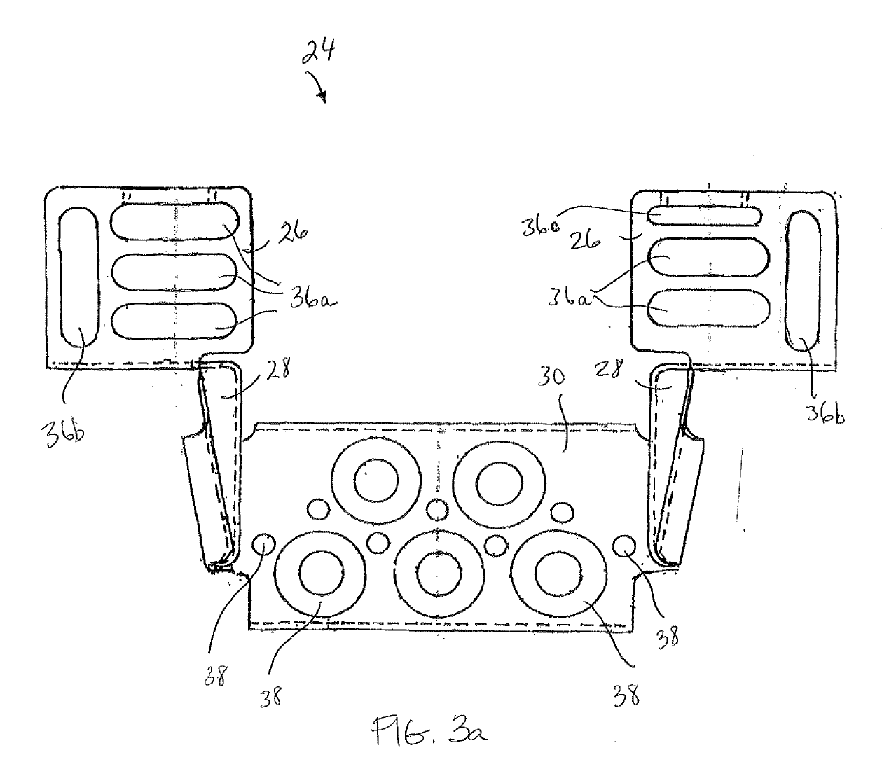

Referring now to the drawings, FIGS. 2a-2c illustrate one preferred embodiment of a helper step arrangement according to the present invention. The helper step arrangement shown includes an upper helper step 24 and a lower helper step 22. The upper helper step 24 is attached to the upper step 14 and the lower helper step 22 is attached to the lower step 12. Both the upper helper step 24 and the lower helper step 22 have an upper mounting portion 26, two side supports 28, and a lower step member 30. The upper mounting portion 26 of each of the lower and upper helper steps 22, 24 is used to attach the helper steps 22, 24 to the steps 12, 14. In FIGS. 2a-2c, bolts 32 and nuts 34 are used in combination with the upper mounting portions 26 of the helper steps 22, 24, but other fastening mechanisms could also be used. The side supports 28 connect the upper mounting portion 26 to the lower step member 30 and are preferably constructed at an angle or slant such that the distance between the side supports 28 near the upper mounting portion 26 is greater than the distance between the side supports 28 near the lower step member 30. This angled or slanted construction is preferable to prevent the helper steps 22, 24 from “parallelogramming” or moving side to side when a load is applied to the step member 30 such as the weight of a driver. The step member 30 can be formed such that it lies directly under the upper mounting portion 26, as shown in FIGS. 2a-2c for the lower helper step 22, or it can be formed such that it lies outboard of the upper mounting portion 26, as shown in FIGS. 2a-2c for the upper helper step 24. The configuration combination shown in FIGS. 2a-2c is desirable in many instances so that the maximum allowable tractor width is not exceeded by the addition of the lower helper step arrangement while the upper helper step has adequate foot clearance from the vehicle, however, either configuration can be used for either helper step. The step member 30 has a stepping surface 31 and functions as a step, allowing the driver to place his or her foot thereon to move between the ground, the lower step 12 and the upper step 14 with less difficulty. The driver would first step on to the lower helper step 22, then step on the lower step 12, then step on the upper helper step 24, and then step on the upper step 14 to gain access to the elevated cab.

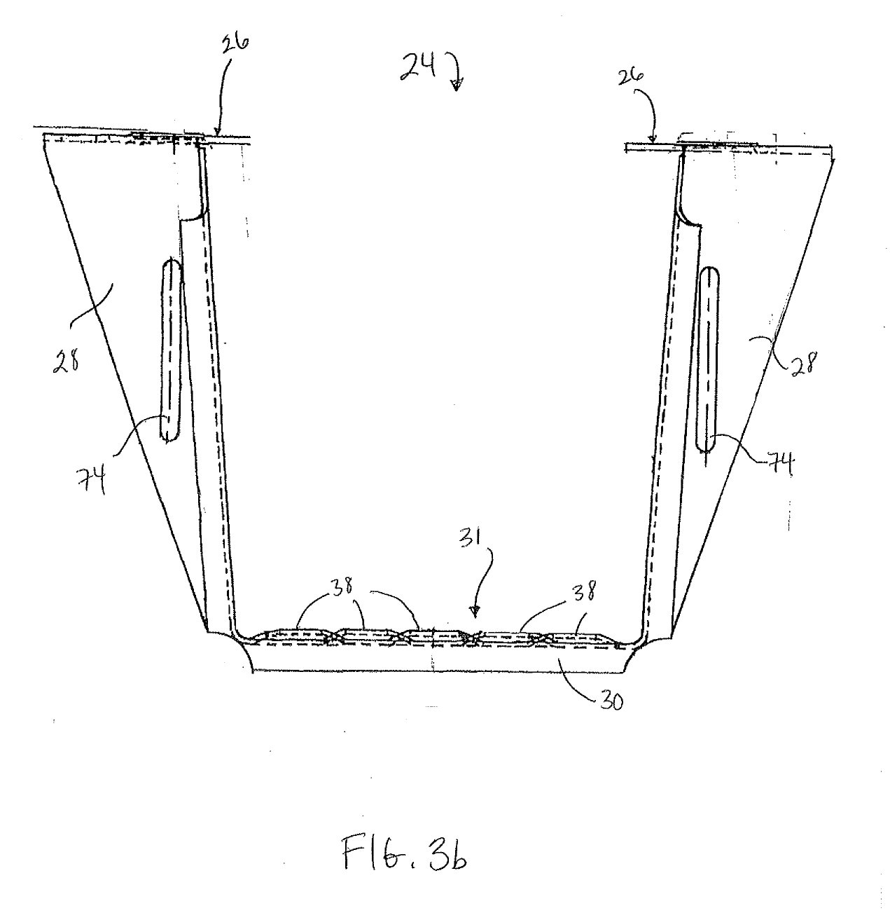

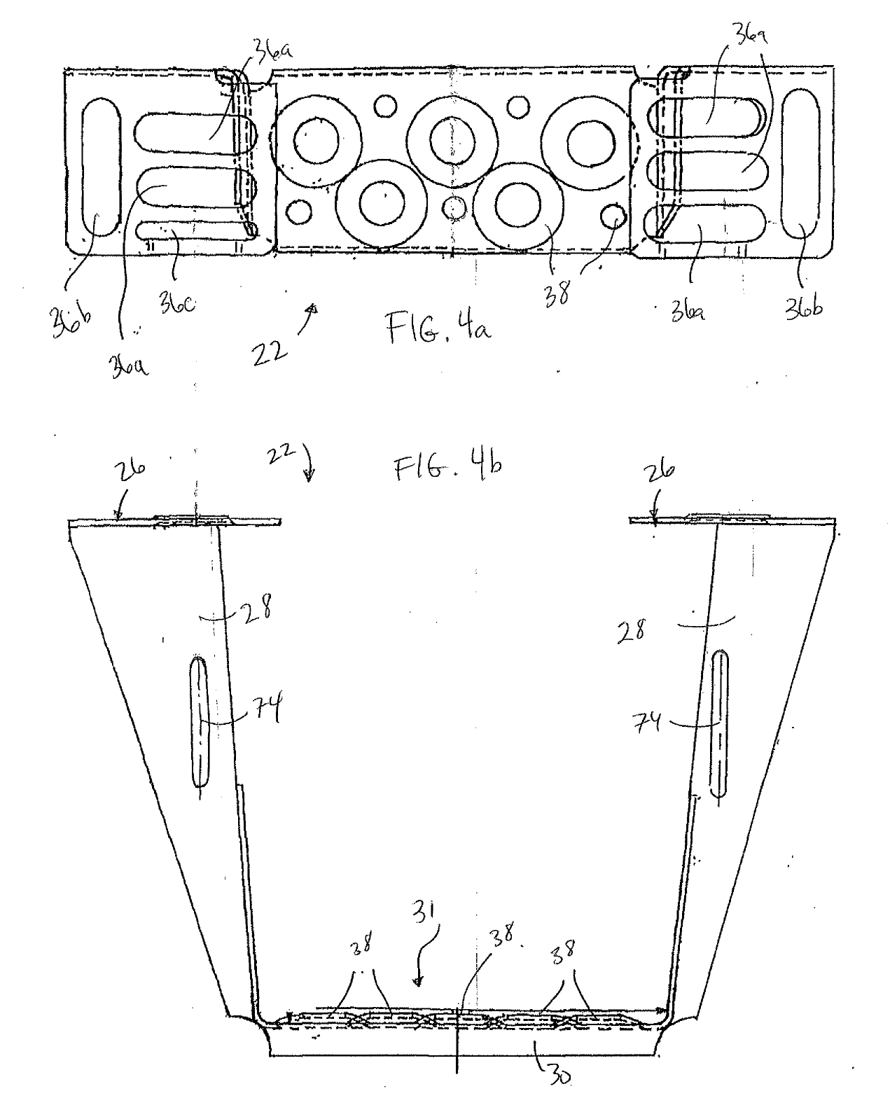

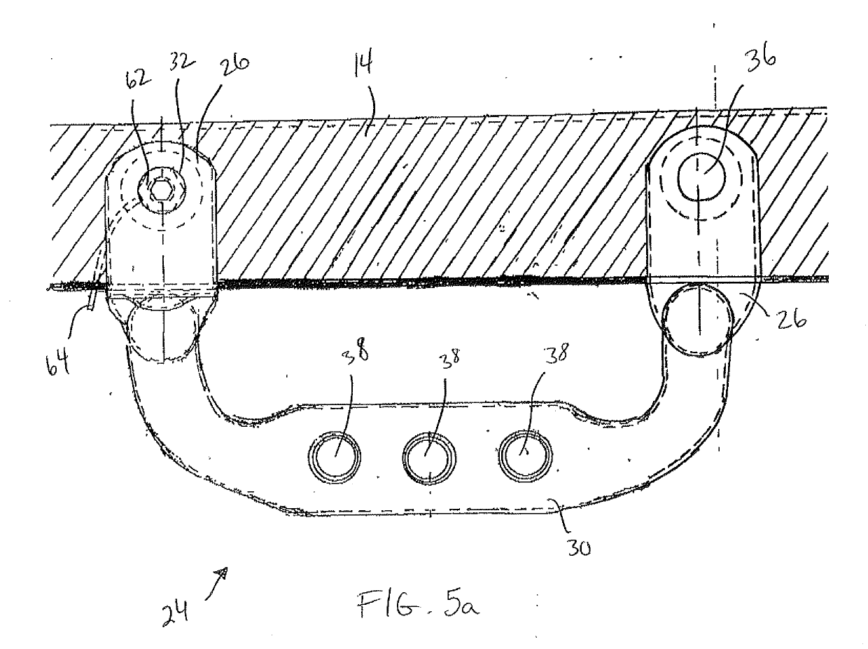

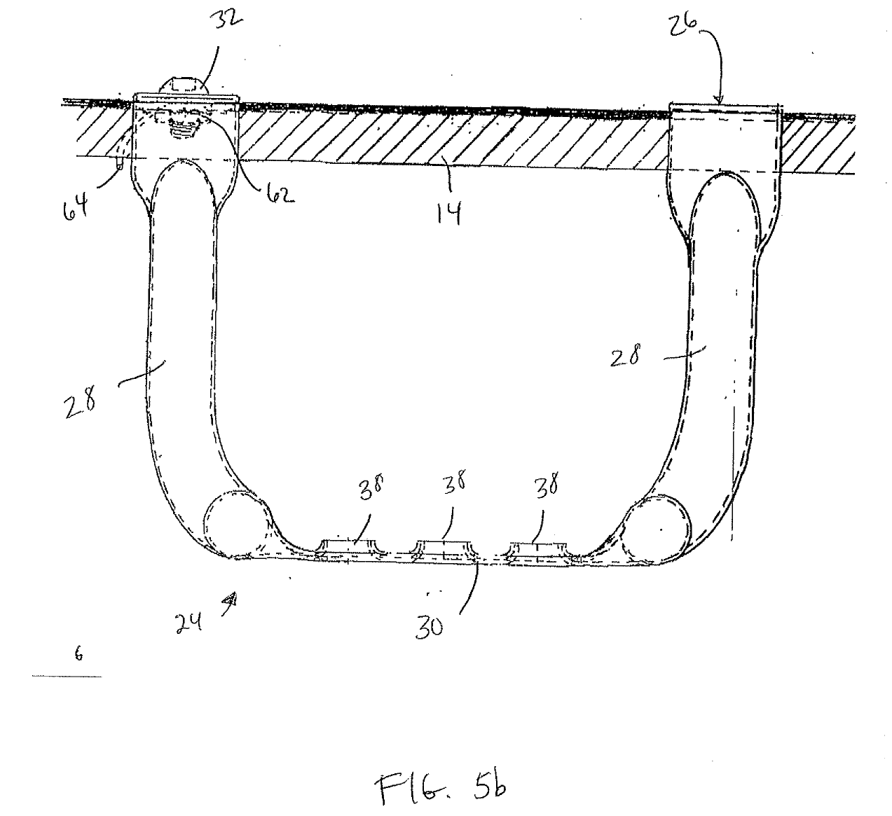

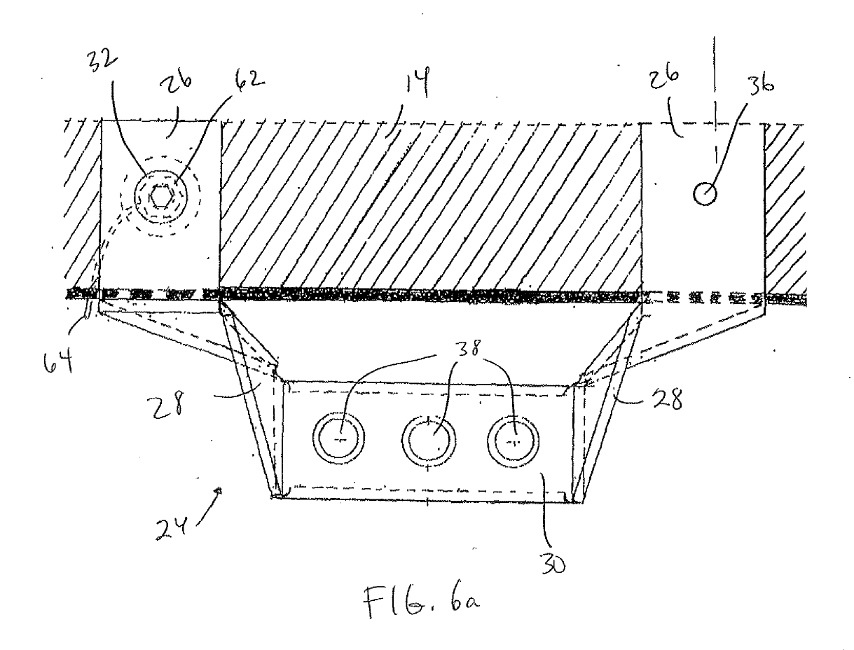

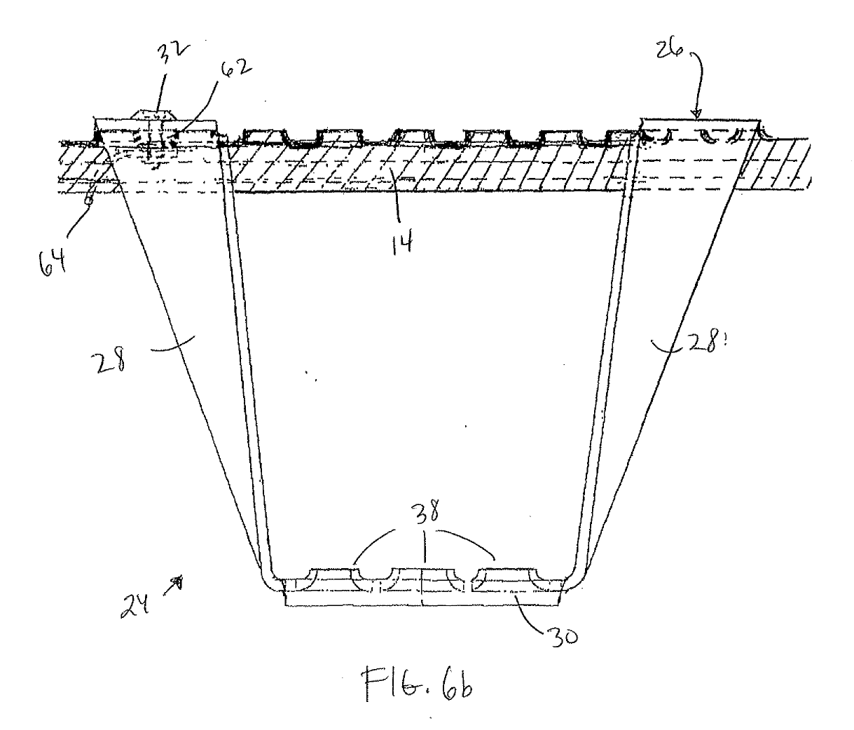

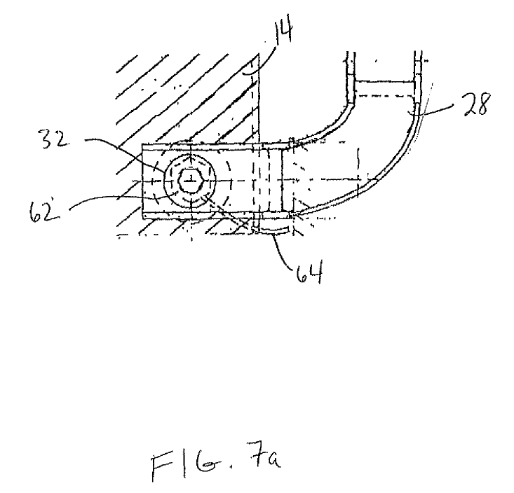

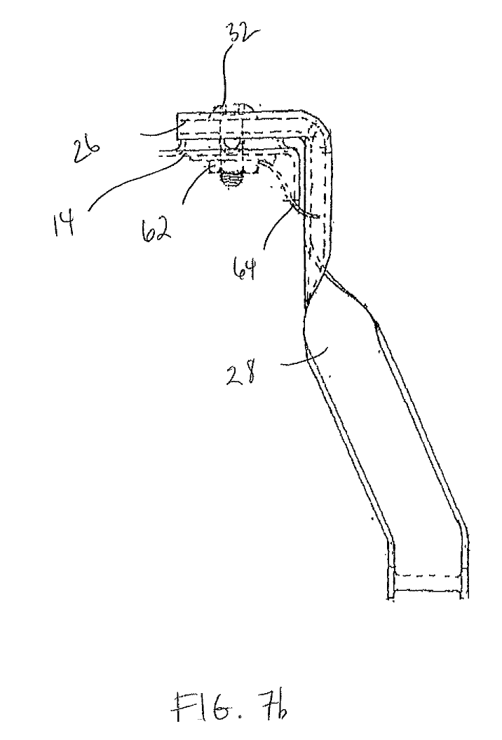

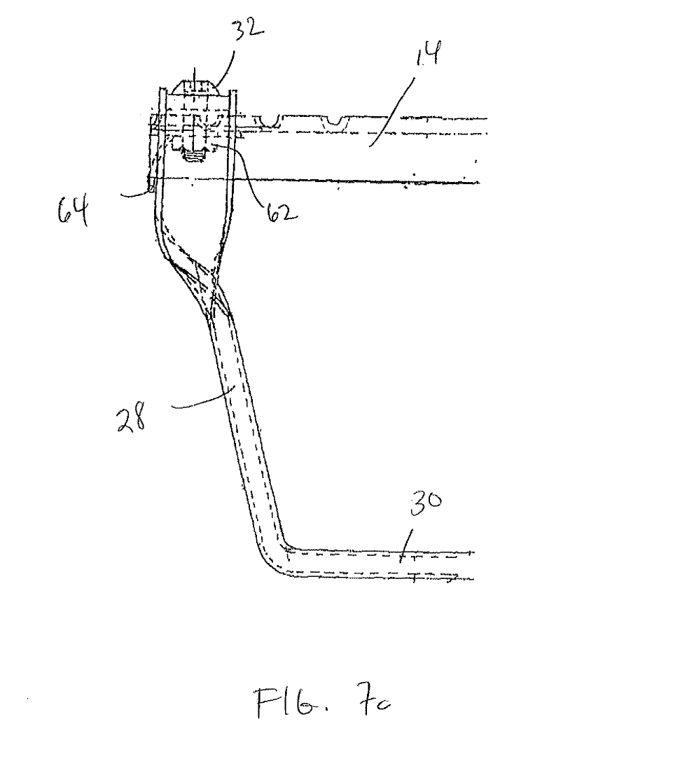

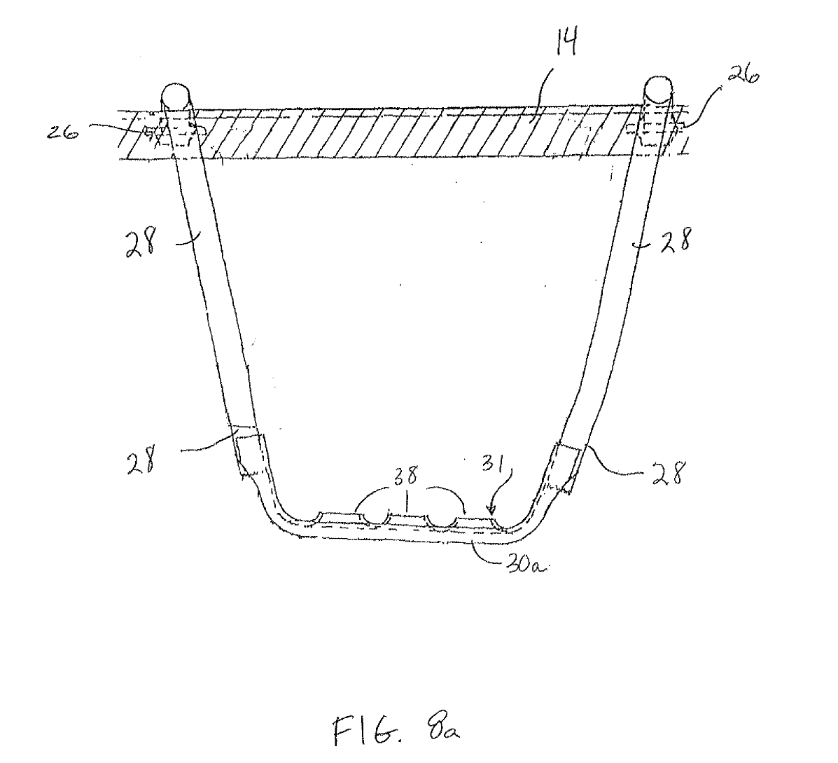

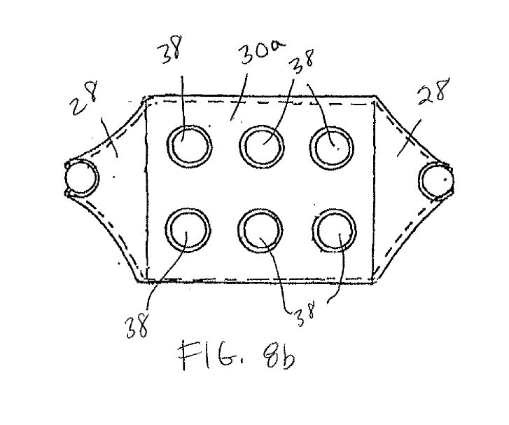

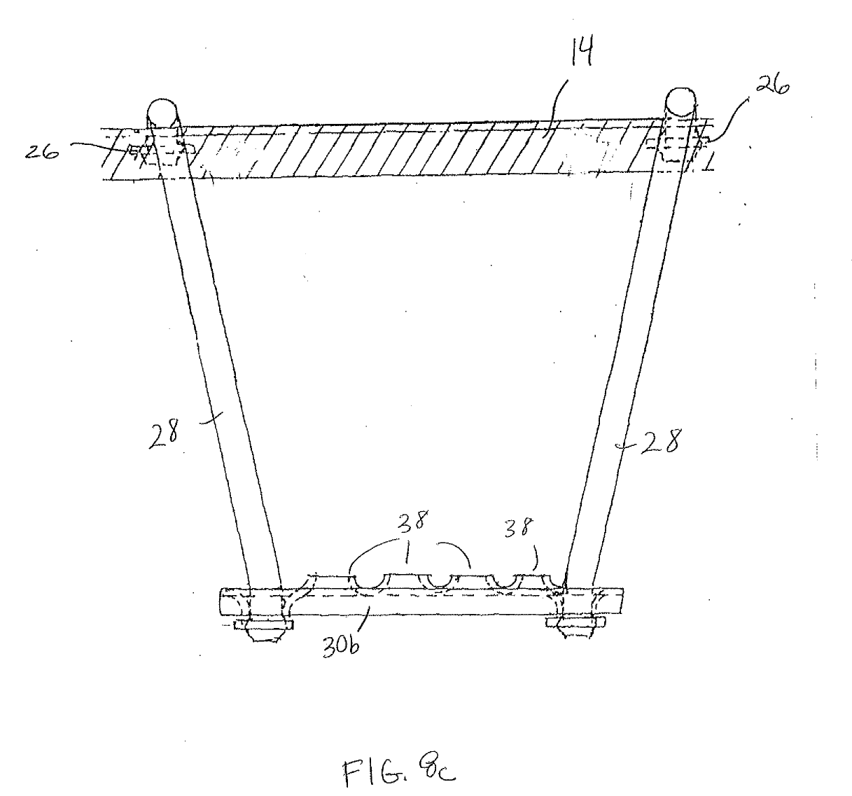

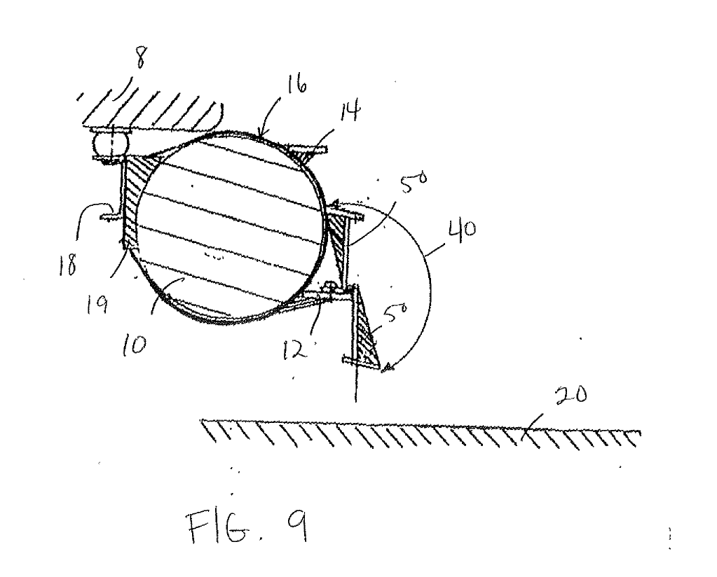

FIGS. 3a and 3b show one preferred embodiment of an upper helper step 24 according to the present invention, and FIGS. 4a and 4b show a preferred embodiment of a lower helper step 22. The embodiments of FIGS. 3a-3b and 4a-4b are formed from a single piece of stamped metal material. Several other methods for making the helper step out of a single piece of material could also be used. For example, the helper step could be made from a formed tube material as shown in FIGS. 5a-5b, a bent strap material as shown in FIGS. 6a-6b, a twisted extrusion or bar material as shown in FIGS. 7a-7c, or cast or forged materials. The embodiments in FIGS. 3a-7c are designed for nearly 100% material utilization, which is cost effective for manufacturing. FIGS. 5a-7a show only an upper helper step 24, however, the same or analogous designs could be used for a lower helper step 22 or a helper step used in another location of the vehicle. While use of a single piece of stamped metal material is beneficial, it is not necessary for the present invention. The upper and lower helper steps 24, 22 could be formed from a number of different pieces and fastened together using any number of conventional fastening means known in the art. For example, FIGS. 8a-8c show an embodiment of the present invention that uses a rope material for the side supports 28 and separate metal pieces for the mounting portions 26 and step member 30. The step member can be formed as a substantially flat step member 30b alone as shown in FIG. 8c, or the step member 30a can be formed to include a portion of the side supports 28 as shown in FIGS. 8a and 8b. The step member 30a is “self-orienting” in that the stepping surface 31 of the step member 30a will naturally tend to face in the upward direction. The rope and metal can be fastened together in a number of ways known in the art, for example, the rope side supports 28 can be cinched into the ends of the metal step member 30a. The advantage of the combination rope and metal (or other rigid material) design is that the rope material would not be subject to impact damage, but one might be concerned that it lacks a “robust image.” Several other materials could also be used, for example, a helper step of the present invention could be injection molded from a composite plastic material.

The upper mounting portions 26 in FIGS. 3a and 3b are formed such that the lower step member 30 lies outboard of the upper mounting portions 26, which is preferable for the upper helper step 24 in many tractor and truck configurations because it allows the step member 30 to extend away from the fuel tank as shown in FIG. 2a, providing adequate toe clearance. The upper mounting portions 26 could also be formed or configured such that the lower step member 30 lies substantially directly beneath the upper mounting portions, as shown in FIGS. 4a and 4b, which is preferable for the lower helper step 22 in many tractor and truck configurations because it does not extend substantially beyond the width of the existing lower step 12 and thus is less likely to pose a problem with exceeding the required overall vehicle width. A number of other relationships between the mounting portions and step member could also be used as might be required for a particular tractor or trucking application. The side supports 28 of FIGS. 3a and 3b can bear against the tank to limit inboard deflection when a driver steps on the step member 30. When doing so, care should be taken to ensure that the surface of the side supports 28 that bears on the tank will not penetrate the tank in a side impact or otherwise damage the tank. Although the differences described herein may be preferable in some instances, it is possible to use the same helper step, or substantially the same helper step, in either the upper helper step or lower helper step position, as well as in a number of other locations on the vehicle.

The upper mounting portion 26 shown in FIGS. 3a-4b includes a plurality of receiving slots 36. Any number of receiving slots 36 can be used, including but not limited to a single receiving slot 36 and the receiving slots 36 can have any number of shapes including but not limited to the rounded rectangle or oval shape shown in FIGS. 3a-4b or the round shape shown in FIGS. 5a, 6a and 7a. The receiving slots 36 are used to facilitate attachment of the upper helper step 24 to the upper step 14, as described in more detail below. The use of a plurality of oval-shaped slots, including at least one slot that is perpendicular to at least one other slot, is particularly useful because it provides a number of possible attachment points to accommodate the wide variety of hole arrangements on steps found on tractors, trailers and trucks. Specifically, it has been found particularly effective to use a slot arrangement, as shown in FIGS. 3a-4b, that includes at least two slots 36a parallel to the edge of the step to which the helper step is mounted, and another slot 36b substantially perpendicular to the parallel slots 36a. In one embodiment, the perpendicular slot 36b can be spaced apart from the parallel slots 36a by about the width of the narrowest of the slots 36. For example, the slots 36 could be about ⅜″ wide and 3″ long. The perpendicular slot 36b would then be spaced apart from the parallel slots 36a by about ⅜″. In another example, the slots 36 could be about ⅝″ wide and 2.5″ long and spaced apart by about ⅜″. A number of different widths, lengths and spaced-apart distances could be used in connection with the present invention; however, to maximize the strength of the attachment, the slots 36 should not be substantially wider than the material between the slots 36. The lengths and widths of any particular slot 36 can also be different than that of the other slots 36. In FIGS. 3a-4b, for instance, slot 36c is a parallel slot that has a smaller width than the other slots 36a, 36b. The parallel slots 36a of one mounting portion 26 could also be offset, for example by about one slot width, from the parallel slots 36a of the other mounting portion 26 to further increase the chances that a pre-existing hole in the step 14 will align with a parallel slot 36a in one of the mounting portions 26. Once a hole is aligned with a parallel slot 36a in one of the mounting portions 26, the helper step 24 can be moved along the parallel slot 36a until a pre-existing hole in the step 14 is aligned with any of the other slots 36 in the other mounting portion 26. When using this offset arrangement, the widths of the slots 36 can be varied to accommodate the offset, as illustrated by the smaller width of slot 36c.

To attach the upper helper step 24 to the upper step 14, the upper mounting portions 26 are placed on top of the upper step 14 and a bolt 32 is passed through one of the receiving slots 36 on each of the upper mounting portions 26 and suitable complementary pass-through points on the upper step 14, such as grating or traction holes. The bolts 32 used can be of any shape but are preferably round-headed to prevent a driver's shoe or boot from catching on them, and can be driven by any suitable tool presently known or later developed in the art such as but not limited to an Allen wrench, Phillips head or flat head screw driver, or conventional wrench. A nut is then used to fasten each of the bolts in place. It has been found particularly useful to employ a flag nut 62 including a flagpole 64 as shown in FIGS. 5a-7c, which allows the installer to manipulate the nut into position on the underside of the step 14. This is particularly useful with tractors, trailers or trucks that have decorative skirts or other structures that cover the fuel tank, because the helper step can be installed using flag nuts 62 without disassembly of the decorative skirt or other covering structures. Analogous attachment steps are used to attach the lower helper step 22 to the lower step 12, and could also be used to attach a helper step of the present invention to a number of other existing structures on the vehicle.

It is also possible to mount the helper step of the present invention simply by drilling the necessary holes in the existing step traction surface or other existing structure on the vehicle and threading drive-screws into the holes formed in that manner, or, using a through-bolt and a nut to attach the helper step to the existing step. It is beneficial, however, to avoid the necessity of modifying the existing structure to attach the helper step. Most pre-existing stepping surfaces have hole patterns and/or open areas amid their step-traction patterns. Therefore, using the helper step of the present invention having the mounting portion described above, in many cases it will not be necessary to drill mounting holes in the pre-existing stepping surface. It is also possible to permanently attach the helper steps to the existing steps or other existing structure on the vehicle by a number of different means known in the art, such as but not limited to welding.

The step member 30 shown in FIGS. 3a-3b and 4a-4b includes an upwardly facing stepping surface having abrasion features 38 that help the driver maintain traction on the helper step. Many different abrasion features could be used, as well as no abrasion features. The abrasion features 38 shown in FIGS. 3a-3b and 4a-4b are raised round abrasion features in an alternating pattern across the step member 30.

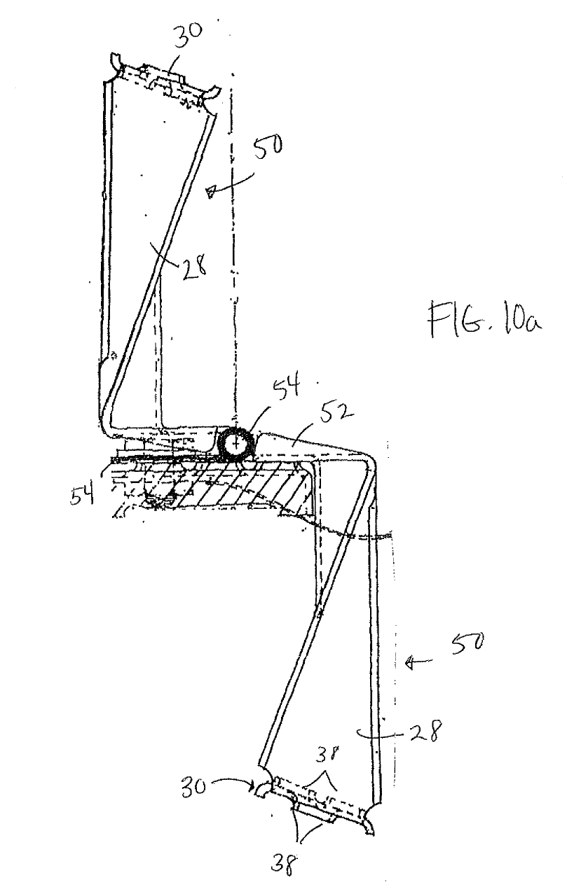

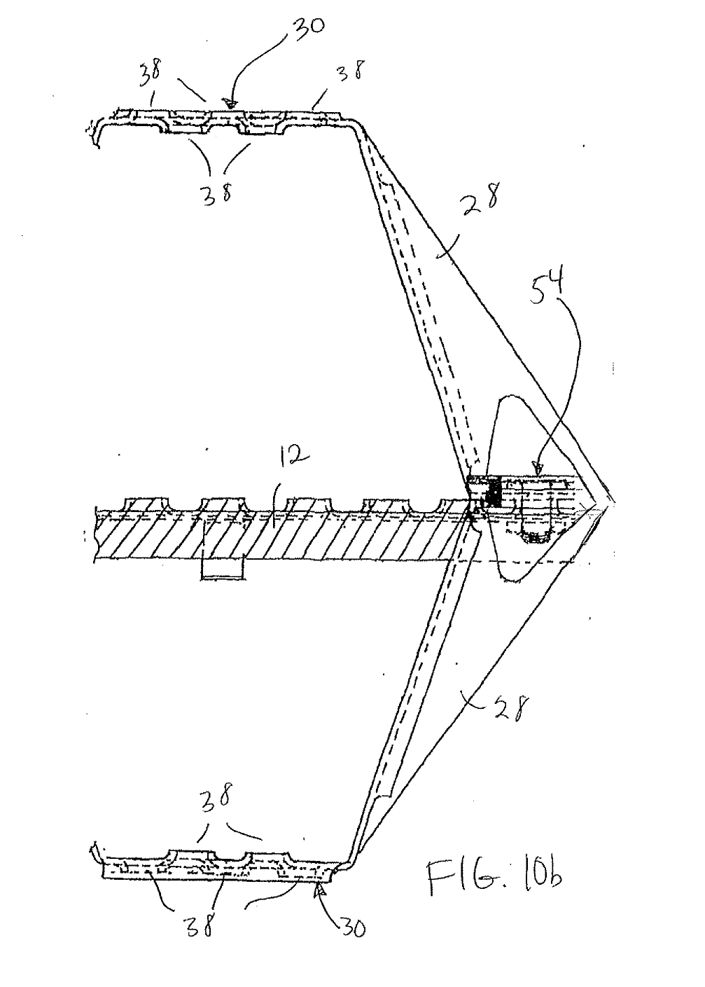

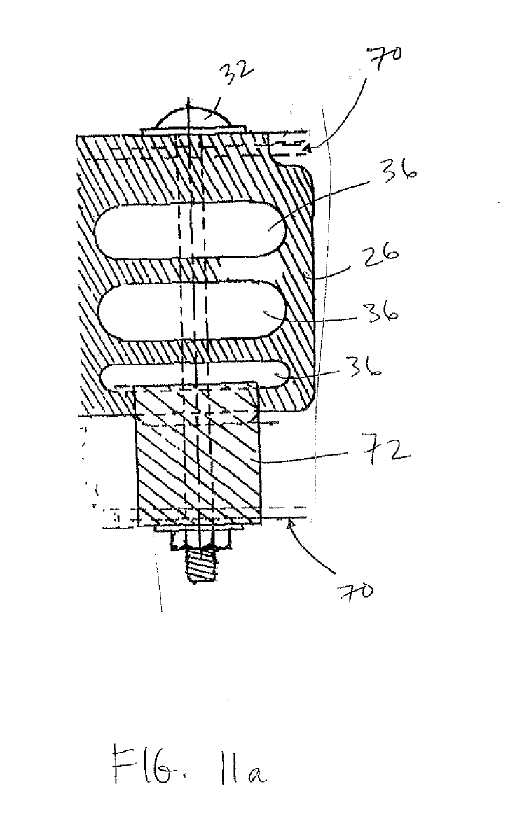

FIGS. 9-10b illustrate the use of a pivoting helper step. The pivoting helper step 50 can be used in connection with both the upper and lower step positions. As shown in FIG. 9 by arrow 40, the pivoting helper step 50 can be used in the lower position and then pivoted into the upper position. As shown in FIGS. 10a-10b, the pivoting step 50 has a mounting portion 52, a hinge 54, side supports 28 and a step member 30. The mounting portion 52 is attached to the lower step 12, and the step member 30 preferably has abrasion features 38 on both sides thereof as both sides will be in contact with a driver's foot as stepping surfaces. In the upper position, the helper step 50 leans against the tank 10 to prevent rotation and in the lower position, it is centered by gravity. A spring-loaded hinge 54 can be used so that the helper step 50 will spring to the upper position when the driver steps off of the helper step 50 in the lower position and on to the lower step 12. To move the helper step 50 back to the lower position from the upper position, a driver could drag the helper step 50 down with his or her foot. The pivoting step 50 can be made in any of the ways previously described and differs only in the addition of the hinge 54 and the fact that only one helper step 50 will be required. It may be advantageous in some circumstances to use the pivoting helper step 50 because it only requires one attachment point.

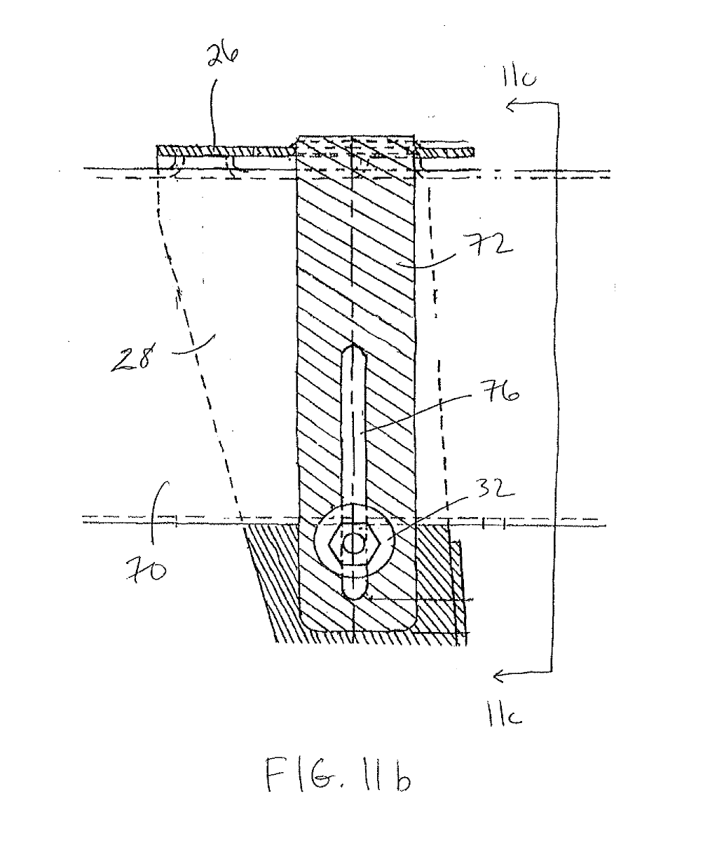

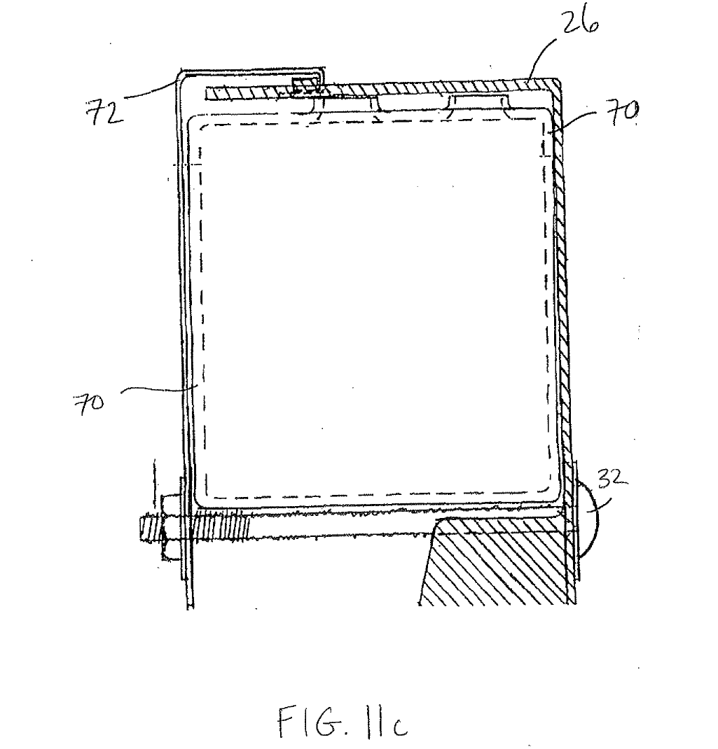

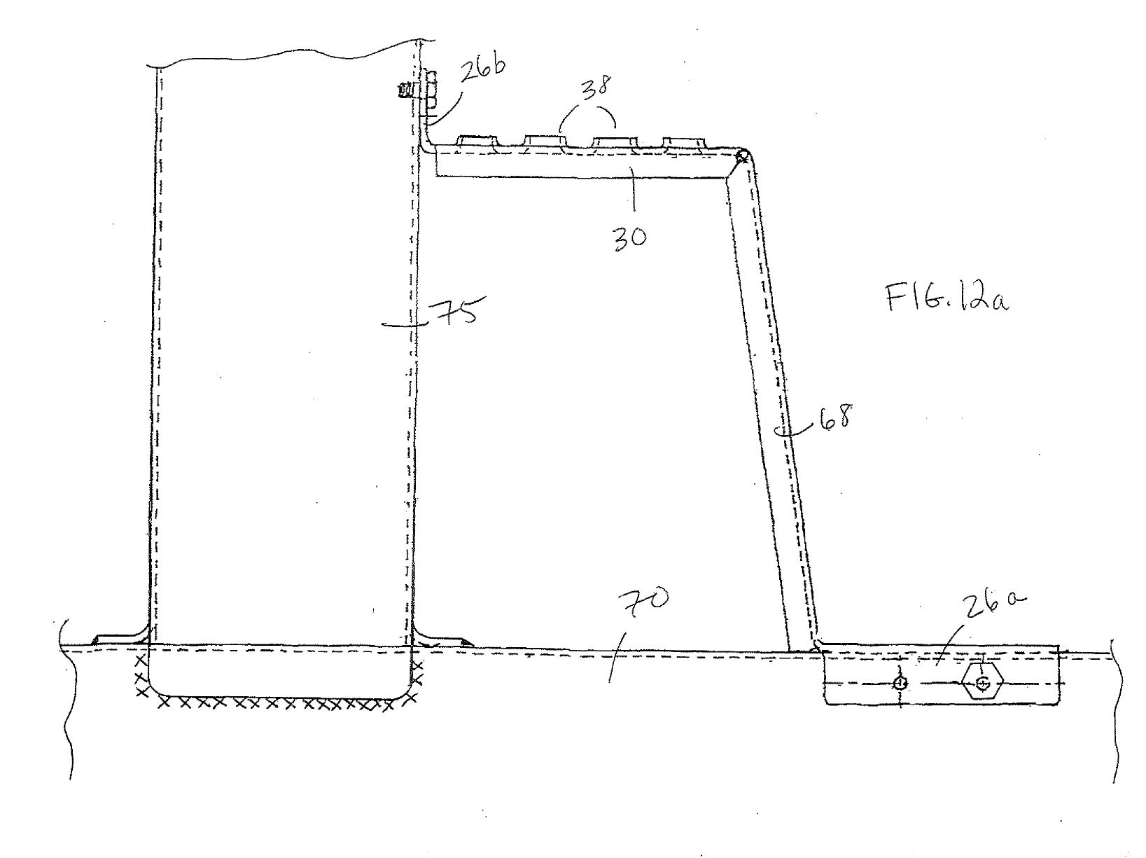

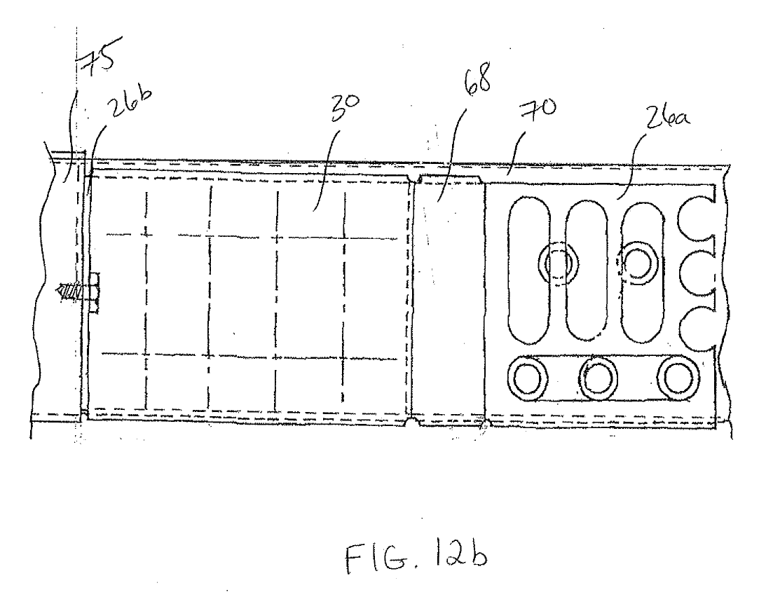

The helper step of the present invention can be used in connection with any of the steps currently found on tractors or trucks, including but not limited to the steps used to gain access to the cab on the driver's side or passenger side, or the steps used to gain access to a sleeper cab, or the steps in the rear of the vehicle used to gain access to the 5^{th} wheel trailer mount. The helper step of the present invention could also be used in connection with other tractor and truck applications where there generally are no existing steps. FIGS. 11a-12b illustrate the use of the helper steps of the present invention to gain access to the rear cargo bay or flatbed of a trailer or truck. Currently, there are some helper steps available to help drivers and others gain access to the rear cargo bay or flatbed, however, the current offerings are comparatively complicated, expensive, heavy and difficult-to-install. Some trailer manufacturers also offer optional welded-in bar steps. Field welding, though, would be subject to higher cost, inconsistent quality, and to corrosion issues at the weld. The use of a helper step of the present invention would solve these and other issues with the current cargo bay or flatbed access steps.

The helper steps of the present invention could mount to the mandatory “under-ride guard” beam to provide access to the cargo bay or flatbed. Often this beam also has traction holes in its upper surface. A lower helper step could be directly mounted to the beam in the same manner as was described for the cab access application, and substantially the same designs could be used. The embodiments of FIGS. 3a-3b and 4a-4b would be particularly useful as a lower step for this application. Use of a through-bolt-nut assembly for mounting the helper step would also work for this application; however, a clearance hole would have to be drilled in the lower surface of the beam. Alternatively, the helper step might attach, again using two bolts 32, via a formed strap 72 as shown in FIGS. 11a-11c that wraps around the guard beam 70. A horizontal bolt 32 would pass through a vertical slot 74 on each helper step side support 28 and through a corresponding slot 76 in its strap 72. Slots 74 for this option are shown in both preferred embodiments of FIGS. 3a-3b and 4a-4b. Recent regulations have standardized the under-ride guard beam to an approximate 4″×4″ closed box beam. The strap 72 and helper step 24 in FIGS. 11a-11c are designed for the standardized beam 70, but could be used in connection with non-standard beams.

FIGS. 12a-12b illustrate one embodiment of an upper helper step 24a mounted to the under-ride guard beam 70 for access to the cargo bay or flatbed. The helper step of this embodiment has a pair of mounting portions 26a, 26b, a step member 30 and a support leg 68. One of the mounting portions 26a of the helper step 24a is attached over the beam 70 as previously described in connection with attachment to the cab access steps, using pre-existing traction holes on the beam 70. The mounting portion 26a is connected to the step member 30 by support leg 68. The other mounting portion 26b is adjacent the step member 30 and bears against a lateral wall of a vertical support 75 of the beam 70. Bearing force alone will suffice in some applications to support use of the helper step 24a at this location, or a supplemental self-tapping drive screw could be added to a hole drilled into that lateral wall of the vertical support 75, or other supplemental attachment could be used.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

I claim:

1. A helper step for a vehicle, the helper step comprising:
at least one mounting portion configured to be attached to an existing structure on the vehicle and having at least one receiving slot defined thereon;
a horizontal step member having at least an upwardly facing stepping surface; and
a pair of side supports extending between the at least one mounting portion and the horizontal step member, the side supports oriented at an angle such that the distance between the side supports near the mounting portion is greater than the distance between the side supports near the horizontal step member.

2. The helper step of claim 1, wherein the mounting portion includes a plurality of receiving slots.

3. The helper step of claim 1, wherein the mounting portion includes at least one receiving slot perpendicular to at least one other receiving slot.

4. The helper step of claim 1, further comprising a pair of mounting portions.

5. The helper step of claim 1, wherein the at least one mounting portion, the pair of side supports and the step member are formed as a single part.

6. The helper step of claim 1, further comprising a hinge disposed in the mounting portion such that the helper step can be pivoted between a first position in which the step member is positioned below the mounting portion and a second position in which the step member is positioned above the mounting portion.

7. The helper step of claim 1, wherein the helper step is attached to an existing step on the vehicle to gain access to a cab of the vehicle.

8. The helper step of claim 1, wherein the side supports include at least one receiving slot.

9. The helper step of claim 1, wherein the helper step can be attached to an under-ride beam on the vehicle to gain access to a cargo bay or flatbed of the vehicle.

10. The helper step of claim 1, further comprising a strap to facilitate attachment of the helper step to an existing structure on the vehicle.

11. A step arrangement for a vehicle, the step arrangement comprising:
at least one pre-existing step having a first horizontal step member with a first upwardly facing stepping surface; and
a helper step secured to the pre-existing step, wherein the helper step includes a second horizontal step member having a second upwardly facing stepping surface located below the first upwardly facing stepping surface.

12. The step arrangement of claim 11, wherein the helper step is mounted to the pre-existing step via fasteners that extend through openings in the first horizontal step member and through receiving slots in a mounting portion of the helper step.

13. The step arrangement of claim 11, wherein the helper step includes a pivotable mounting arrangement for moving the helper step between a lowered position in which the second horizontal step member is located below the first upwardly facing stepping surface, and a raised position in which the second horizontal step member is located above the first upwardly facing stepping surface.

14. A step arrangement for a vehicle, the step arrangement comprising:
a first step mounted in connection with a fuel tank support strap on a vehicle;
a second step mounted in connection with the fuel tank support strap, the second step positioned above the first step;
a first helper step mounted to the first step, wherein the first helper step includes at least one mounting portion, a horizontal step member, and a pair of side supports connecting the mounting portion to the step member;
a second helper step mounted to the second step, wherein the second helper step includes at least one mounting portion, a horizontal step member, and a pair of side supports connecting the mounting portion to the step member; and
wherein the step member of the first helper step is positioned below the first step, and the step member of the second helper step is positioned above the first step but below the second step.

15. The step arrangement of claim 14, wherein the side supports are oriented at an angle such that the distance between the side supports near the mounting portion is greater than the distance between the side supports near the step member.

16. The step arrangement of claim 14, wherein the at least one mounting portion includes a plurality of receiving slots, the plurality of receiving slots including at least one perpendicular receiving slot that is perpendicular to at least one other receiving slot.

17. The step arrangement of claim 16, wherein the at least one perpendicular receiving slot is spaced apart from the at least one other receiving slot by about the width of the perpendicular receiving slot.

18. The step arrangement of claim 16, wherein the at least one mounting portion includes at least two receiving slots that are parallel to one another.

19. The step arrangement of claim 16, wherein the helper step includes two mounting portions, and wherein each of the mounting portions has at least two receiving slots that are parallel to one another, and wherein the location of the parallel receiving slots on one of the mounting portions is offset from the location of the parallel receiving slots on the other mounting portion.

20. The step arrangement of claim 14, wherein the step members of the first and second helper steps include abrasion features.
